(19) United States
(12) Patent Application Publication
(10) Pub. No.: US 2023/0086251 A1
(43) Pub. Date: Mar. 23, 2023

(54) SYSTEM AND METHOD FOR GENERATING RECOMMENDATIONS BASED ON APPLICATIONS INSTALLED ON A COMPUTING DEVICE

(71) Applicant: The Toronto-Dominion Bank, Toronto (CA)

(72) Inventors: Tomasz Pawelkiewicz, Toronto (CA); Rachit Srivastava, Brampton (CA); Ekas Kaur Rai, Mississauga (CA); Dalbir Channa, Markham (CA)

(73) Assignee: The Toronto-Dominion Bank, Toronto (CA)

(21) Appl. No.: 17/481,571

(22) Filed: Sep. 22, 2021

(51) Int. Cl. G06Q 30/02

(52) U.S. Cl. CPC G06Q 30/0241; G06Q 30/0224

(57) ABSTRACT

A server computer system comprises a processor; a communications module coupled to the processor; and a memory coupled to the processor, the memory storing instructions that, when executed, configure the processor to obtain loyalty point data associated with one or more loyalty point accounts; determine one or more applications installed on a computing device; generate, based at least on the one or more applications installed on the computing device, a recommendation for redeeming loyalty points from one or more of the loyalty point accounts; and send, via the communications module and to the computing device, a signal causing the computing device to display a selectable affordance to accept the recommendation.

### TECHNICAL FIELD

The present application relates to systems and methods for generating recommendations based on applications installed on a computing device.

### BACKGROUND

There are various loyalty point programs available. The loyalty point programs may be associated with merchants, financial institutions, credit card providers, airlines, etc.

Oftentimes, a user may be unaware that they have loyalty points that may be redeemed.

### BRIEF DESCRIPTION OF THE DRAWINGS

Embodiments are described in detail below, with reference to the following drawings:

FIG. 1 is a schematic operation diagram illustrating an operating environment of an example embodiment;

FIG. 2A is a high-level schematic diagram of an example computing device;

FIG. 2B is a schematic block diagram showing a simplified organization of software components stored in memory of the example computing device of FIG. 2A;

FIG. 3 is an example user interface;

FIG. 4 is another example user interface;

FIG. 5 shows, in flowchart form, an example method for linking an account hosted by a third party server;

FIG. 6 is another example user interface;

FIG. 7 is another example user interface;

FIG. 8 is another example user interface;

FIG. 9 shows, in flowchart form, an example method for generating recommendations based on applications installed on a computing device;

FIG. 10 shows, in flowchart form, an example method for obtaining a list of applications installed on a computing device;

FIG. 11 is another example user interface;

FIG. 12 is another example user interface;

FIG. 13 is another example user interface;

FIG. 14 shows, in flowchart form, an example method for crediting an account associated with one of the applications installed on a computing device;

FIG. 15 is another user interface;

FIG. 16 is another user interface; and

FIG. 17 is another user interface.

Like reference numerals are used in the drawings to denote like elements and features.

### DETAILED DESCRIPTION OF VARIOUS EMBODIMENTS

In an aspect there is provided a server computer system comprising a processor; a communications module coupled to the processor; and a memory coupled to the processor, the memory storing instructions that, when executed, configure the processor to obtain loyalty point data associated with one or more loyalty point accounts; determine one or more applications installed on a computing device; generate, based at least on the one or more applications installed on the computing device, a recommendation for redeeming loyalty points from one or more of the loyalty point accounts; and send, via the communications module and to the computing device, a signal causing the computing device to display a selectable affordance to accept the recommendation.

In one or more embodiments, when determining the one or more applications installed on the computing device, the instructions, when executed, further configure the processor to send, via the communications module and to the computing device, a signal that includes a command requesting a list of applications installed on the computing device; and receive, via the communications module and from the computing device, a signal that includes the list of applications installed on the computing device.

In one or more embodiments, the list of applications installed on the computing device is received from the computing device in one of a plain text format or a HyperText Markup Language format.

In one or more embodiments, the instructions, when executed, further configure the processor to analyze the list of applications installed on the computing device to identify one or more applications eligible for loyalty point redemption.

In one or more embodiments, the instructions, when executed, further configure the processor to store, in a database, a list that includes only the applications installed on the computing device that are identified as being eligible for loyalty point redemption.

In one or more embodiments, when analyzing the list of applications, the instructions, when executed, further configure the processor to perform, using a lookup table stored in a database, a lookup of each application installed on the computing device to determine if the application is eligible for loyalty point redemption.

In one or more embodiments, the instructions, when executed, further configure the processor to receive, via the communications module and from the computing device, a signal indicating selection of the selectable affordance to accept the recommendation; and responsive to receiving the signal indicating selection of selectable affordance to accept the recommendation, debit an amount of loyalty points from the one or more loyalty point accounts and credit an account associated with one of the applications with an amount based on the amount of loyalty points debited from the one or more loyalty point accounts.

In one or more embodiments, the instructions, when executed, further configure the processor to obtain, from a database, a conversion rate for converting loyalty points to a dollar amount, wherein the amount credited to the account associated with one of the applications is determined based on the obtained conversion rate.

In one or more embodiments, the account associated with the one of the applications is one of the one or more loyalty point accounts.

In one or more embodiments, when obtaining loyalty point data associated with one or more loyalty point accounts, the instructions, when executed, further configure the processor to obtain authentication information associated with the one or more loyalty point accounts; send, via the communications module and to a third party server associated with the one or more loyalty point accounts, a signal that includes the authentication information and a request for loyalty point data; and receive, via the communications module and from the third party server associated with the one or more loyalty point accounts, the loyalty point data.

In one or more embodiments, the recommendation includes a recommendation to link an account associated with one or more of the applications installed on the computing device.

In one or more embodiments, the instructions, when executed, further configure the processor to engage an application programming interface (API) associated with one of the applications installed on the computing device to obtain an account balance of an account associated with the one of the applications; determine that the account balance is below a threshold; and responsive to determining that the account balance is below the threshold, generate the recommendation.

In another aspect there is provided a method comprising obtaining loyalty point data associated with one or more loyalty point accounts; determining one or more applications installed on a computing device; generating, based at least on the one or more applications installed on the computing device, a recommendation for redeeming loyalty points from one or more of the loyalty point accounts; and sending, to the computing device, a signal causing the computing device to display a selectable affordance to accept the recommendation.

In one or more embodiments, determining the one or more applications installed on the computing device comprises sending, to the computing device, a signal that includes a command requesting a list of applications installed on the computing device; and receiving, from the computing device, a signal that includes the list of applications installed on the computing device.

In one or more embodiments, the list of applications installed on the computing device is received in one of a plain text format or a HyperText Markup Language format.

In one or more embodiments, the method further comprises analyzing the list of applications installed on the computing device to identify one or more applications eligible for loyalty point redemption.

In one or more embodiments, the method further comprises storing, in a database, a list that includes only the applications installed on the computing device identified as being eligible for loyalty point redemption.

In one or more embodiments, analyzing the list of applications comprises performing, using a lookup table stored in a database, a lookup of each application installed on the computing device to determine if the application is eligible for loyalty point redemption.

In one or more embodiments, the method further comprises receiving, from the computing device, a signal indicating selection of the selectable affordance to accept the recommendation; and responsive to receiving the signal indicating selection of selectable affordance to accept the recommendation, debiting an amount of loyalty points from the one or more loyalty point accounts and crediting an account associated with one of the applications with an amount based on the amount of loyalty points debited from the one or more loyalty point accounts.

In another aspect there is provided a non-transitory computer readable storage medium comprising processor-executable instructions which, when executed, configure a processor to obtain loyalty point data associated with one or more loyalty point accounts; determine one or more applications installed on a computing device; generate, based at least on the one or more applications installed on the computing device, a recommendation for redeeming loyalty points from one or more of the loyalty point accounts; and send, via a communications module and to the computing device, a signal causing the computing device to display a selectable affordance to accept the recommendation.

Other aspects and features of the present application will be understood by those of ordinary skill in the art from a review of the following description of examples in conjunction with the accompanying figures.

In the present application, the term “and/or” is intended to cover all possible combinations and sub-combinations of the listed elements, including any one of the listed elements alone, any sub-combination, or all of the elements, and without necessarily excluding additional elements.

In the present application, the phrase “at least one of . . . or . . . ” is intended to cover any one or more of the listed elements, including any one of the listed elements alone, any sub-combination, or all of the elements, without necessarily excluding any additional elements, and without necessarily requiring all of the elements.

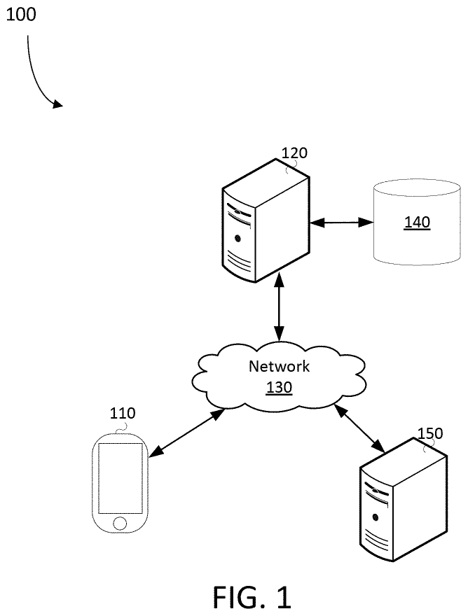

FIG. 1 is a schematic operation diagram illustrating an operating environment of an example embodiment. As shown, the system 100 includes a computing device 110 and a server computer system 120 coupled to one another through a network 130, which may include a public network such as the Internet and/or a private network. The computing device 110 and the server computer system 120 may be in geographically disparate locations. Put differently, the computing device 110 and the server computer system 120 may be located remote from one another.

The computing device 110 may take a variety of forms including, for example, a mobile communication device such as a smartphone, a tablet computer, a wearable computer (such as a head-mounted display or smartwatch), a laptop or desktop computer, or a computing device of another type. The computing device 110 may be associated with a user or customer having resources that are managed by or via the server computer system 120. For example, the server computer system 120 may be a financial institution server and the user may be a customer of a financial institution operating the financial institution server. As another example, the server computer system 120 may be a server associated with a loyalty points provider and the user may be a customer of the loyalty points provider. The computing device 110 may store software instructions that cause the computing device 110 to establish communications with the server computer system 120.

The server computer system 120 may maintain a database 140 that includes various data records. The database 140 may include data records for a plurality of resource accounts and at least some of the data records may define a quantity of resources associated with a user or customer. For example, the user that is associated with the computing device 110 may be associated with one or more resource accounts having one or more data records in the database 140. The data records may reflect a quantity of resources that are available to the user. Such resources may include owned resources and, in at least some embodiments, borrowed resources (e.g., resources available on credit). The quantity of resources that are available to or associated with a user may be reflected by a balance defined in an associated data record such as, for example, a bank balance. The resource accounts may include, for example, a chequing account, a savings account, a borrowing account such as for example a line of credit account, a credit card account, a loyalty point account, etc. As such, at least some of the data records may define a chequing account balance, a savings account balance, a line of credit account balance, a credit card account balance, a loyalty point account balance, etc.

The database 140 may store or maintain a number of lists and/or lookup tables. For example, the database 140 may store a lookup table that includes a list of mobile applications eligible for loyalty point redemption and a corresponding conversion rate for the loyalty point redemption. As another example, the database 140 may store a list of mobile applications installed on the computing device 110 that are identified as being eligible for loyalty point redemption.

The network 130 is a computer network. In some embodiments, the network 130 may be an internetwork such as may be formed of one or more interconnected computer networks. For example, the network 130 may be or may include an Ethernet network, an asynchronous transfer mode (ATM) network, a wireless network, a telecommunications network, or the like.

The computing device 110 is adapted to present a graphical user interface that allows for communication with the server computer system 120. For example, the computing device 110 may be adapted to receive, from the server computer system 120, a signal that causes the computing device 110 to display an interface associated with a loyalty point management application.

The system 100 may include a third party server 150 that maintains data records associated with one or more users. The third party server 150 may be associated with a mobile application installed on the computing device 110 and the data records maintained by the third party server 150 may represent accounts held by customers or users of the mobile application. The data records may store account data such as for example loyalty point data or rewards data which may include a loyalty points balance or a resource balance.

The third party server 150 may require authentication information to access the data records and the authentication information may be provided, for example, in the form of a username/password or in the form of an access token.

The third party server 150 may be configured to communicate with the server computer system 120 via the network 130. The third party server 150 may provide account data to the server computer system 120. In one or more embodiments, the third party server 150 may be associated with or may include an application programming interface (API) that may be configured to receive API calls from the server computer system 120. The API calls may include a request for account data and/or may include a request for depositing loyalty points or resources into a particular account maintained by the third party server 150.

It will be appreciated that the system 100 may include additional third party servers.

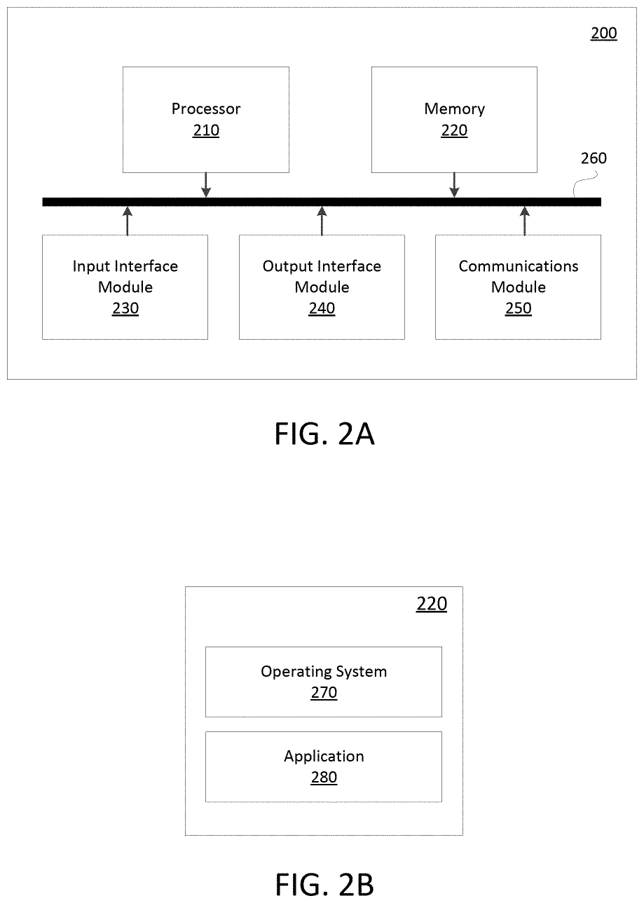

FIG. 2A is a high-level operation diagram of an example computer device 200. In some embodiments, the example computer device 200 may be exemplary of one or more of the computing device 110, the server computer system 120 and/or the third party server 150. The example computer device 200 includes a variety of modules. For example, as illustrated, the example computer device 200, may include a processor 210, a memory 220, an input interface module 230, an output interface module 240, and a communications module 250. As illustrated, the foregoing example modules of the example computer device 200 are in communication over a bus 260.

The processor 210 is a hardware processor. Processor 210 may, for example, be one or more ARM, Intel x86, PowerPC processors, or the like.

The memory 220 allows data to be stored and retrieved. The memory 220 may include, for example, random access memory, read-only memory, and persistent storage. Persistent storage may be, for example, flash memory, a solid-state drive, or the like. Read-only memory and persistent storage are a computer-readable medium. A computer-readable medium may be organized using a file system such as may be administered by an operating system governing overall operation of the example computer device 200.

The input interface module 230 allows the example computer device 200 to receive input signals. Input signals may, for example, correspond to input received from a user. The input interface module 230 may serve to interconnect the example computer device 200 with one or more input devices. Input signals may be received from input devices by the input interface module 230. Input devices may, for example, include a touchscreen input, keyboard, trackball, or the like. In some embodiments, all or a portion of the input interface module 230 may be integrated with an input device. For example, the input interface module 230 may be integrated with one of the aforementioned example input devices.

The output interface module 240 allows the example computer device 200 to provide output signals. Some output signals may, for example, allow provision of output to a user. The output interface module 240 may serve to interconnect the example computer device 200 with one or more output devices. Output signals may be sent to output devices by output interface module 240. Output devices may include, for example, a display screen such as, for example, a liquid crystal display (LCD), a touchscreen display. Additionally, or alternatively, output devices may include devices other than screens such as for example a speaker, indicator lamps (such as for example light-emitting diodes (LEDs)), and printers. In some embodiments, all or a portion of the output interface module 240 may be integrated with an output device. For example, the output interface module 240 may be integrated with one of the aforementioned example output devices.

The communications module 250 allows the example computer device 200 to communicate with other electronic devices and/or various communications networks. For example, the communications module 250 may allow the example computer device 200 to send or receive communications signals. Communications signals may be sent or received according to one or more protocols or according to one or more standards. For example, the communications module 250 may allow the example computer device 200 to communicate via a cellular data network, such as for example, according to one or more standards such as, for example, Global System for Mobile Communications (GSM), Code Division Multiple Access (CDMA), Evolution Data Optimized (EVDO), Long-term Evolution (LTE) or the like. Additionally, or alternatively, the communications module 250 may allow the example computer device 200 to communicate using near-field communication (NFC), via Wi-Fi™, using Bluetooth™ or via some combination of one or more networks or protocols. Contactless payments may be made using NFC. In some embodiments, all or a portion of the communications module 250 may be integrated into a component of the example computer device 200. For example, the communications module may be integrated into a communications chipset.

Software comprising instructions is executed by the processor 210 from a computer-readable medium. For example, software may be loaded into random-access memory from persistent storage of memory 220. Additionally, or alternatively, instructions may be executed by the processor 210 directly from read-only memory of memory 220.

FIG. 2B depicts a simplified organization of software components stored in memory 220 of the example computer device 200. As illustrated these software components include an operating system 270 and an application 280.

The operating system 270 is software. The operating system 270 allows the application 280 to access the processor 210, the memory 220, the input interface module 230, the output interface module 240 and the communications module 250. The operating system 270 may be, for example, Apple iOS™, Google Android™, Linux, Microsoft Windows™, or the like.

The application 280 adapts the example computer device 200, in combination with the operating system 270, to operate as a device performing specific functions. It will be appreciated that although a single application 280 is shown, in operation the memory 220 may include more than one application 280 and different applications 280 may perform different operations. For example, in at least some embodiments in which the computer device 200 is functioning as the computing device 110, the applications 280 may include a banking application. The banking application may be configured for secure communications with the server computer system 120 and may provide various banking functions such as, for example, the ability to display a quantum of value in one or more data records (e.g. display balances), configure or request that operations such as transfers of value (e.g. bill payments, email money transfers and other transfers) be performed, and other account management functions.

By way of further example, in at least some embodiments in which the computer device 200 functions as the computing device 110, the applications 280 may include a web browser, which may also be referred to as an Internet browser. In at least some such embodiments, the server computer system 120 may be a web server. The web server may cooperate with the web browser and may serve as an interface when the interface is requested through the web browser. For example, the web browser may serve as a mobile banking interface. The mobile banking interface may provide various banking functions such as, for example, the ability to display a quantum of value in one or more data records (e.g. display balances), configure or request that operations such as transfers of value (e.g. bill payments and other transfers) be performed, and other account management functions.

By way of further example, in at least some embodiments in which the computer device 200 functions as the computing device 110, the applications 280 may include a loyalty point management application.

The loyalty point management application may be configured for secure communications with the server computer system 120 and may provide various loyalty point management functions such as for example the ability to link one or more loyalty point accounts hosted by one or more third party servers, the ability to display account data associated with one or more linked accounts hosted by one or more third party servers, and other management functions. It will be appreciated that the loyalty point management application may be provided as a separate application and/or may be associated with or available within the banking application or via mobile banking.

The user may access the loyalty point management application on the computing device 110. For example, the user may select a selectable affordance within the mobile banking application that, when selected, directs the computing device 110 to the loyalty point management application. As another example, the loyalty point management application may be downloaded onto the computing device 110. As another example, the computing device 110 may access the loyalty point management application using an internet browser resident on the computing device 110.

The user may be required to provide authentication information to access the loyalty point management application. For example, using the computing device 110, the user may enter a username and password associated with their account and the computing device 110 may send a signal that includes the username and password to the server computer system 120. The server computer system 120 may verify the authentication information and may identify the account of the user.

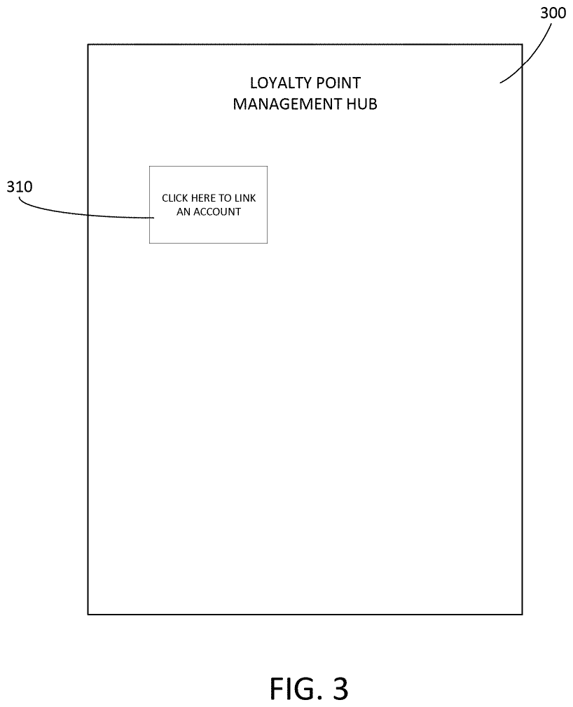

Within the loyalty point management application, the computing device 110 may display a loyalty point management interface. An example loyalty point management interface 300 is shown in FIG. 3. As can be seen, the loyalty point management interface 300 includes a selectable affordance 310 that, when selected, sends a signal to the server computer system 120 indicating that the user would like to link one or more loyalty point accounts hosted by one or more third party servers to the loyalty point management application. The selectable affordance 310 may be selected by the user performing, for example, a tap gesture on a display screen of the computing device 110 at a location corresponding to the selectable affordance 310.

Responsive to the user selecting the selectable affordance 310, the computing device 110 displays a list of loyalty point programs that are available to be linked. The list of loyalty point programs may be a predefined or predetermined list generated by the server computer system 120. The list of loyalty point programs may be a list of loyalty point programs that the server computer system 120 is able to access account data therefrom. For example, the list of loyalty point programs may only include loyalty point programs that are associated with third party servers that the server computer system 120 is able to communicate with or has previously communicated with. The list of loyalty point programs may additionally or alternatively include loyalty point programs that provide an application programming interface (API) that may be engaged by the server computer system 120 to handle API requests.

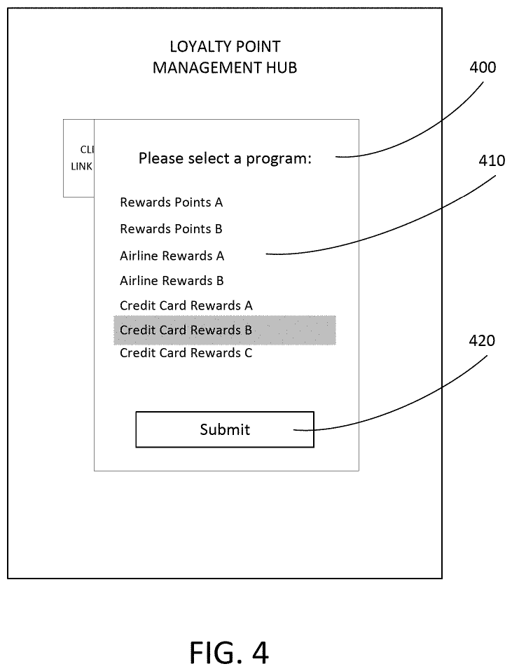

An example interface 400 that includes a list of loyalty point programs 410 is shown in FIG. 4. In this example, the interface 400 is displayed such that it overlaps the loyalty point management interface 300 shown in FIG. 3. The list of loyalty point programs 410 includes loyalty point programs known to the server computer system 120. A loyalty point program may be selected by the user performing, for example, a tap gesture on a display screen of the computing device 110 at a location corresponding to one of the loyalty point programs. The interface 400 includes a selectable affordance 420 that, when selected, causes the computing device 110 to send a signal to the server computer system 120 that includes information identifying the selected loyalty point program.

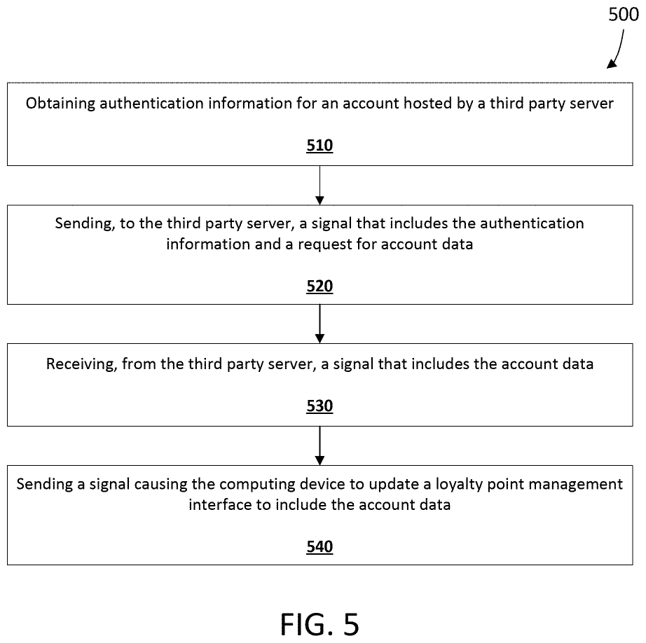

Once a loyalty point program has been selected, a method for linking an account hosted by a third party server associated with the loyalty point program is performed. Reference is made to FIG. 5, which illustrates, in flowchart form, a method 500 for linking an account hosted by a third party server. The method 500 may be implemented by a computing device having suitable processor-executable instructions for causing the computing device to carry out the described operations. The method 500 may be implemented, in whole or in part, by the server computer system 120. The server computer system 120 may off-load some operations of the method 500 to the computing device 110 (FIG. 1).

The method 500 includes obtaining authentication information for an account hosted by a third party server (step 510).

The account hosted by the third party server may be associated with an account of the user.

In this embodiment, responsive to receiving the signal that includes information identifying the selected loyalty point program, the server computer system 120 sends a signal causing the computing device 110 to display an interface requesting that the user provide authentication information that may be used to access their account hosted by the third party server. It will be appreciated that different loyalty point programs may require different types of authentication information and as such the interface may be dependent on the selected loyalty point program. For example, a first loyalty point program may require a username and a password to access an account. As another example, a second loyalty point program may require an account number and a password to access an account. The server computer system 120 may store information identifying what type of authentication information is required for each loyalty point program in the database 140. For example, the server computer system 120 and/or the database 140 may maintain a lookup table that includes a list of loyalty point programs and the type of authentication information required to access the account. In this manner, the server computer system 120 may update, adjust or modify the interface prior to it being displayed on the computing device 110 to ensure that the requested authentication information is accurate for the selected loyalty point program.

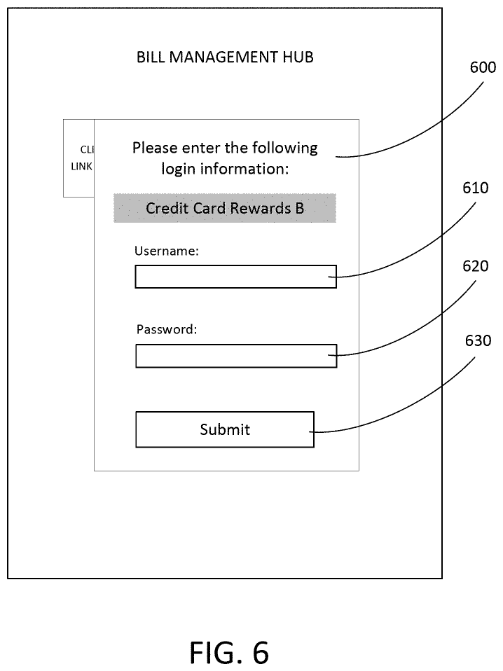

An example interface 600 requesting that the user provide authentication information is shown in FIG. 6. As can be seen, the interface 600 includes a first input field 610 to enter a username associated with an account and a second input field 620 to enter a password associated with the account. The interface 600 includes a selectable affordance 630 that, when selected, sends a signal that includes the authentication information to the server computer system 120. Once received, the server computer system 120 may store the authentication information in memory. The user may complete the first input field 610 and the second input field 620 using, for example, a keyboard displayed on a display screen of the computing device 110.

The method 500 includes sending, to the third party server, a signal that includes the authentication information and a request for account data (step 520).

Once the authentication information has been received, the server computer system 120 uses the authentication information to access the account. Specifically, the server computer system 120 may send, to the third party server, a signal that includes the authentication information and a request for account data. In response, the third party server may analyze the authentication information to authenticate the server computer system 120 and identify the account. Once authenticated, the third party server may retrieve the requested account data and may send the requested account data to the server computer system 120.

In one or more embodiments, the server computer system 120 may engage an application programming interface (API) associated with the third party server and may send, for example, an API request that includes the authentication information and requests account data from the third party server.

The requested account data may include, for example, loyalty point data and the loyalty point data may include a loyalty point balance. The loyalty point data may additionally include a loyalty point conversion rate defined by the third party server. For example, the third party server may include a loyalty point conversion rate for converting the loyalty points to another loyalty point type or for converting the loyalty points to a dollar amount.

The method 500 includes receiving, from the third party server, a signal that includes the account data (step 530).

In this embodiment, the third party server may obtain the requested account data associated with the account. For example, the server computer system 120 may request loyalty point data that includes a loyalty points balance of the account. As such, the third party server may obtain the loyalty points balance of the account and may send a signal that includes the loyalty points balance to the server computer system 120. In this manner, the server computer system 120 receives the account data. The loyalty point data may additionally include, for example, a loyalty point account number and loyalty point transaction history.

The method 500 includes sending a signal causing the computing device to update the loyalty point management interface to include the account data (step 540).

The server computer system 120 sends a signal that causes the computing device 110 to update the loyalty point management interface to include the account data. For example, where the requested account data includes loyalty point data such as the loyalty points balance of the account, the bill management interface may be updated to display the loyalty point data.

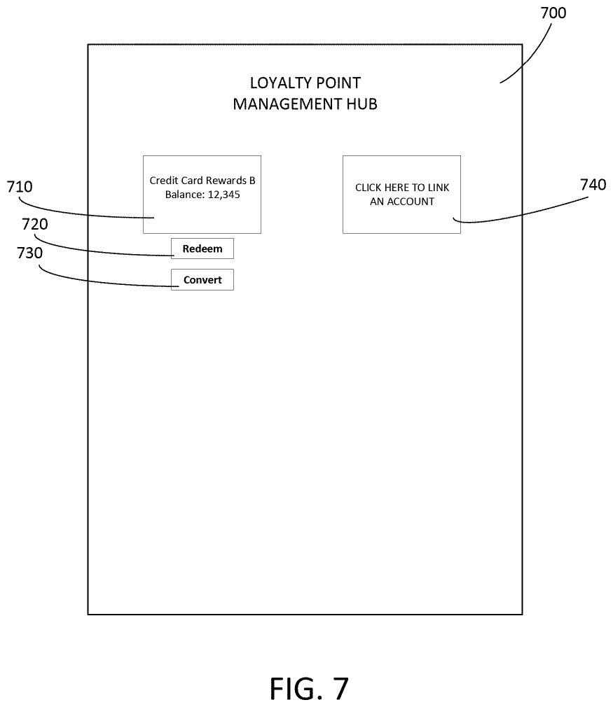

An example interface 700 is shown in FIG. 7. As can be seen, the interface 700 includes a graphic element 710 that includes the account data. Specifically, the graphic element 710 includes identifying information of the loyalty point program (“Credit Card Rewards B”) and the loyalty points balance (12,345 points). The interface 700 includes a selectable affordance 720 for redeeming the loyalty points and a selectable affordance 730 for converting the loyalty points to a different type of loyalty points and this may be based on a conversion rate that may be included with the loyalty point data or may be predefined by the server computer system 120 and stored in the database 140. Operations performed responsive to selection of the selectable affordance 720, 730 will be described in more detail below.

The graphic element 710 may itself be selectable by the user. For example, the user may perform a tap gesture on a display screen of the computing device 110 at a location corresponding to the graphic element 710. In one example, responsive to the user selecting the graphic element 710, the server computer system 120 may provide additional account data for display on the computing device 110. For example, the server computer system 120 may send the loyalty point account number and loyalty point transaction history obtained from the third party server and this may be displayed on the computing device 110. In another example, responsive to the user selecting the graphic element 710, the computing device 110 may be directed to a mobile application or website hosted by the third party server. The user may then log into their account hosted by the third party server and may access their loyalty point account. In the example shown in FIG. 7, selection of the graphic element 710 may direct the computing device to a mobile application associated with “Credit Card Rewards B.”

The interface 700 may include a selectable affordance 740 that may be selected by the user to link one or more additional accounts and this may be completed in manners similar to that described herein. Once completed, account data for all linked accounts may be displayed.

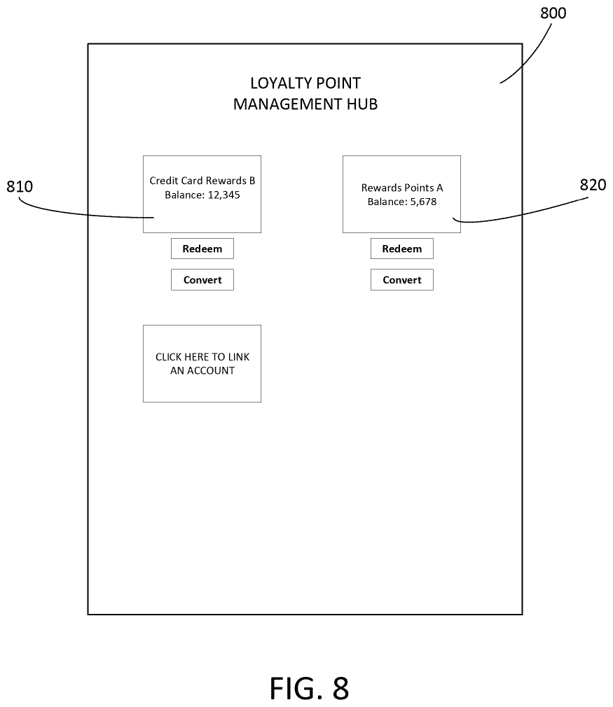

An example interface 800 is shown in FIG. 8. As can be seen, the interface 800 includes graphic elements 810 and 820, each of which is associated with a particular account that has been linked to the loyalty point management application. In this manner, each time the user accesses the loyalty point management application, the server computer system 120 may perform steps to obtain up-to-date account data and display the up-to-date account data within the graphic elements 810 and 820.

It will be appreciated that one or more accounts may be automatically linked to the loyalty point management application. For example, the server computer system 120 may host a loyalty point account for the user and as such the server computer system 120 may automatically link the loyalty point account to the loyalty point management application and may display account data associated with the account therewithin. In this example, the server computer system 120 may be associated with a financial institution, loyalty points provider and/or credit card provider.

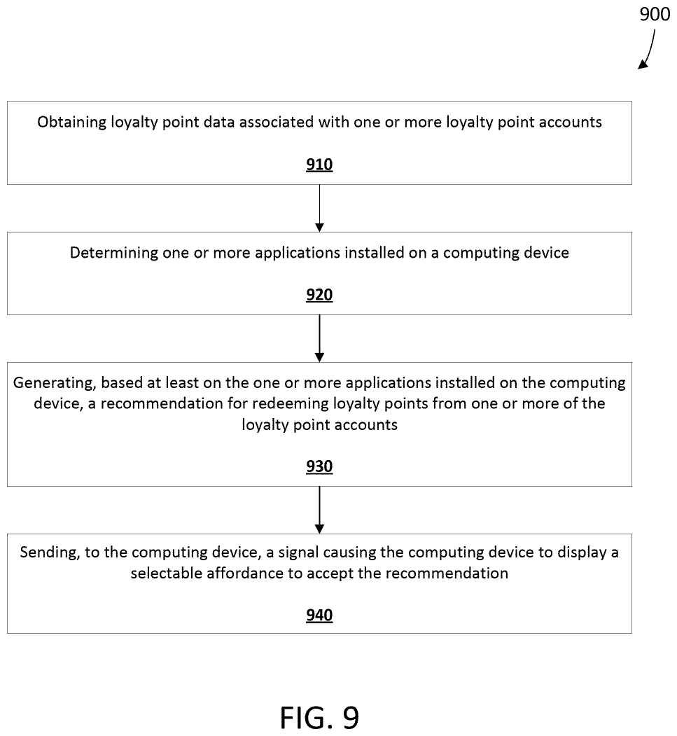

The server computer system 120 may generate recommendations to redeem loyalty points and/or to link additional loyalty point accounts to the loyalty point management application. Reference is made to FIG. 9, which illustrates, in flowchart form, a method 900 for initiating data record creation at a third party server. The method 900 may be implemented by a computing device having suitable processor-executable instructions for causing the computing device to carry out the described operations. The method 900 may be implemented, in whole or in part, by the server computer system 120. The server computer system 120 may off-load some operations of the method 900 to the computing device 110 (FIG. 1).

The method 900 includes obtaining loyalty point data associated with one or more loyalty point accounts (step 910).

The server computer system 120 may obtain the loyalty point data in manners similar to that described herein with reference to method 500. The server computer system 120 may obtain the loyalty point data for all loyalty point accounts linked to the loyalty point management application and this may be done each time the loyalty point management application is opened or loaded onto the computing device 110 and/or each time the user logs into the loyalty point management application.

The method 900 includes determining one or more applications installed on a computing device (step 920).

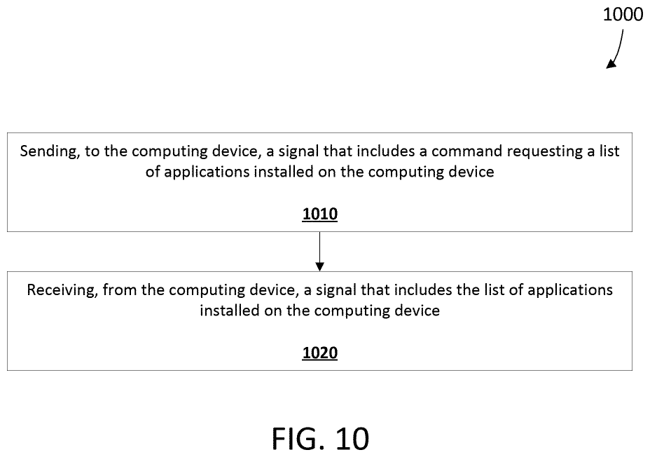

Reference is made to FIG. 10, which illustrates, in flowchart form, a method 1000 for determining one or more applications installed on a computing device. The method 1000 may be implemented by a computing device having suitable processor-executable instructions for causing the computing device to carry out the described operations. The method 1000 may be implemented, in whole or in part, by the server computer system 120. The server computer system 120 may off-load some operations of the method 1000 to the computing device 110 (FIG. 1).

The method 1000 includes sending, to the computing device, a signal that includes a command requesting a list of applications installed on the computing device (step 1010).

The command may be sent in a machine-readable format to the computing device 110. The computing device 110 receives the signal that includes the command and generates a response to the command. In this embodiment, the response to the command may include a list of applications and the list of applications may be generated by the computing device in plain text format or HyperText Markup Language (HTML) format.

The method 1000 includes receiving, from the computing device, a signal that includes the list of applications installed on the computing device (step 1020).

The computing device 110 sends a signal that includes the list of applications. The server computer system 120 receives the signal that includes the list of applications. As mentioned, the list of applications may be in plain text format or HTML format.

Responsive to receiving the list of applications, the server computer system 120 may analyze the list of applications installed on the computing device to identify one or more applications eligible for loyalty point redemption. As will be appreciated, applications identified as being eligible for loyalty point redemption may include applications known to be associated with accounts, loyalty points programs, rewards programs, etc. that are eligible for loyalty point redemption.

As mentioned, the database 140 may store a lookup table that includes a list of mobile applications eligible for loyalty point redemption and a corresponding conversion rate for the loyalty point redemption. As such, to identify applications stored on the computing device 110 eligible for loyalty point redemption, the server computer system 120 may consult the lookup table. Specifically, the server computer system 120 may perform, using the lookup table stored in the database 140, a lookup of each application installed on the computing device 110 to determine if the application is eligible for loyalty point redemption. It will be appreciated that the lookup table may only include applications that are eligible for loyalty point redemption and as such if a particular application is not found in the lookup table it is assumed that the application is not eligible for loyalty point redemption.

The lookup table may additionally include a list of loyalty point types that may be redeemed for each application and as such the server computer system 120 may determine one or more loyalty point types that may be redeemed for an account associated with the application.

The server computer system 120 may generate a list that includes only the applications installed on the computing device 110 that are identified as being eligible for loyalty point redemption and may store the list in the database 140 in association with the account of the user of the computing device 110. Put another way, the server computer system 120 may discard any applications that are not eligible for loyalty point redemption and as such the list that includes only the applications installed on the computing device 110 that are identified as being eligible for loyalty point redemption occupies reduced memory in the database 140 and thus requires less computing resources than a list that includes all of the applications installed on the computing device 110.

The list stored in the database 140 may additionally include loyalty point types that may be redeemed for each application and this may be determined using the lookup table.

The method 900 includes generating, based at least on the one or more applications installed on the computing device, a recommendation for redeeming loyalty points from one or more of the loyalty point accounts (step 930).

In this embodiment, the recommendation may be generated based on what loyalty point accounts the user has linked to the loyalty point management application and based on which applications are identified as being eligible for loyalty point redemption.

The recommendation may be generated in response to determining that one of the applications installed on the computing device 110 is eligible for loyalty point redemption and that the user has linked one or more loyalty point accounts to the loyalty point management application that have loyalty points of a particular type. Put another way, the server computer system 120 may determine that the user has loyalty points of a particular type and that the particular type of loyalty points are eligible to be redeemed for an account associated with a particular application installed on the computing device 110.

As one example, the user may link their “Credit Card Rewards B” account to the loyalty point management application. The server computer system 120 may identify that an application “Coffee Shop Card” is installed on the computing device 110 and may consult the lookup table stored in the database 140 to determine that “Credit Card Rewards B” loyalty points can be redeemed for the “Coffee Shop Card” application. As such, the server computer system 120 may generate a recommendation to redeem “Credit Card Rewards B” loyalty points for the “Coffee Shop Card” application.

One or more applications installed on the computing device 110 may have accounts associated therewith and each account may store loyalty points and/or currency. For example, a particular application may require a user to have an account and the account may store currency that may be used for purchases at a merchant associated with the particular application. The particular application may be configured to display a machine-readable code that may be scanned by a device located at the merchant to complete a purchase using currency or loyalty points stored in the account.

The server computer system 120 may obtain a conversion rate for either redeeming or converting loyalty points from one or more of the linked loyalty point accounts to an account associated with a particular application. For example, the server computer system 120 may obtain a conversion rate for either redeeming or converting loyalty points from the “Credit Card Rewards B” loyalty points type to a loyalty points type associated with the “Coffee Shop Card” application or to a dollar amount that may be applied to an account associated with the “Coffee Shop Card” application.

As one example, the server computer system 120 may determine that 10,000 “Credit Card Rewards B” loyalty points may be converted to $25.00 that may be loaded into an account associated with the “Coffee Shop Card” application. As another example, the server computer system 120 may determine that 10,000 “Credit Card Rewards B” loyalty points may be converted to 10 loyalty points of a loyalty point type associated with the “Coffee Shop Card” application.

The recommendation may additionally or alternatively include a recommendation to link an account associated with a particular mobile application to the loyalty point management application. For example, the server computer system 120 may identify a particular application installed on the computing device 110 that is eligible for loyalty point redemption and may generate a recommendation to link an account associated with the particular application to the loyalty point management application.

The server computer system 120 may engage an artificial intelligence recommendation engine and the artificial intelligence recommendation engine may utilize machine learning techniques to generate the recommendations. For example, the server computer system 120 may provide the artificial intelligence recommendation engine access to the database 140 to generate the recommendations. Using the data obtained from the database 140, the artificial intelligence recommendation engine may filter the data to provide relevant recommendations to the user. Filtering the data may include utilizing a content-based filter, cluster analysis and/or a collaborative filter. The artificial intelligence recommendation engine may generate the recommendations in real-time or near-real-time and this may be done each time the user has accessed the loyalty point management application.

The method 900 includes sending, to the computing device, a signal causing the computing device to display a selectable affordance to accept the recommendation (step 940).

The server computer system 120 may send a signal causing the computing device 110 to display a selectable affordance to accept the recommendation. The signal may cause the computing device 110 to update the loyalty point management interface to include the selectable affordance to accept the recommendation. For example, the interface 800 shown in FIG. 8 may be updated.

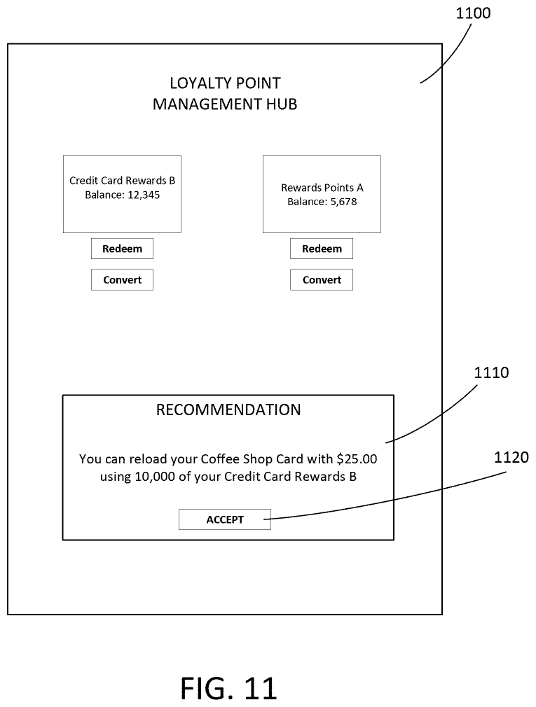

An example interface 1100 that includes a recommendation 1110 is shown in FIG. 11. The recommendation 1110 is a recommendation to redeem 10,000 “Credit Card Rewards B” loyalty points to reload an account associated with a “Coffee Shop Card” with $25.00. The recommendation 1110 includes a selectable affordance 1120 that, when selected, indicates that the user would like to redeem 10,000 loyalty points to reload their account associated with the “Coffee Shop Card” application installed on the computing device 110.

In the example shown in FIG. 11, the interface is updated such that the recommendation is displayed within a specific portion of the loyalty point management interface. The specific portion may correspond to the location of the recommendation 1110. Put another way, a portion of the loyalty point management interface may be reserved to display notifications. In the event that the user has linked a large number of accounts to the loyalty point management application, a size of the graphic elements associated with each linked account may be automatically adjusted to ensure all graphic elements fit within the loyalty point management interface while a portion of the loyalty point management interface remains reserved to display recommendations. The portion reserved to display recommendations may be located, for example, at the top of the loyalty point management interface or at the bottom of the loyalty point management interface.

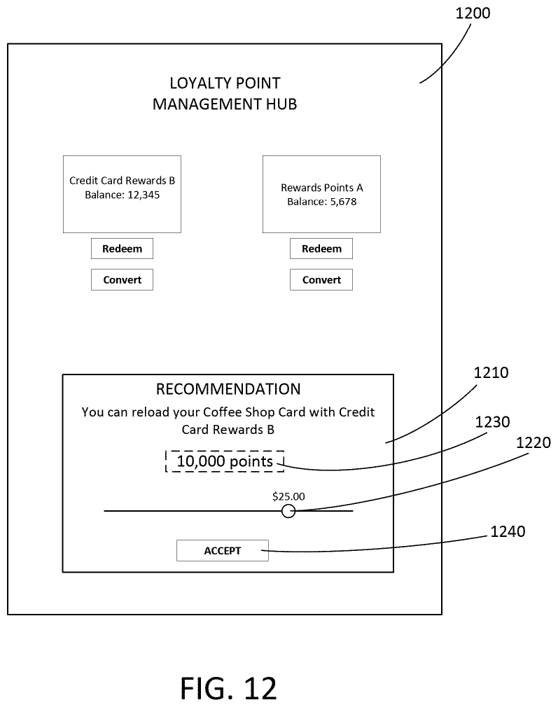

In another example, the recommendation may include one or more adjustable elements that may be used to adjust an amount of loyalty points to be redeemed. An example interface 1200 that includes a recommendation 1210 having an adjustable element 1220 is shown in FIG. 12. In this example, the adjustable element 1220 is in the form of a slider. The adjustable element 1220 may be adjusted by the user to define an amount of loyalty points to be redeemed. Responsive to the user adjusting the adjustable element 1220, a field 1230 is updated to indicate the amount of loyalty points based on the position of the slider. In this example, the user may adjust the adjustable element 1220 by moving the slider to the left to reduce the amount of loyalty points to be redeemed and may adjust the adjustable element 1220 by moving the slider to the right to increase the amount of loyalty points to be redeemed. In this example, text is displayed adjacent to the slider to indicate a dollar amount and this may be based on the conversion rate of loyalty points to dollar amount as determined by the server computer system 120. It will be appreciated that the field 1230 and the text may be updated in real-time in response to the user adjusting the adjustable element 1220. It will also be appreciated that the scale of the adjustable element 1220 may be dependent on the amount of loyalty points available in the loyalty points account. For example, a maximum value of the adjustable element 1220 may be equal to the amount of loyalty points available in the loyalty points account. The recommendation 1210 includes a selectable affordance 1240 to accept the recommendation.

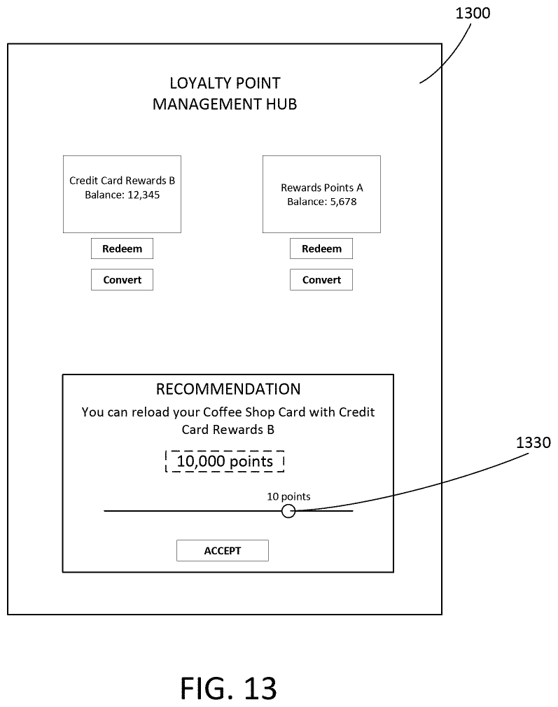

As mentioned, the conversion rate for redeeming loyalty points may be a conversion rate of loyalty points to dollar amount or a conversion rate of loyalty points of a particular type to loyalty points of another type. As such, rather than displaying text that indicates a dollar amount (as shown in FIG. 12) the text may indicate loyalty points. An example interface 1300 is shown in FIG. 13. The interface 1300 is similar to interface 1200 with the following exceptions. In this example, the text displayed adjacent to the slider or adjustable element 1330 indicates an amount of loyalty points to be deposited into an account associated with the application installed on the computing device 110 and this may be based on the conversion rate of loyalty points of a particular loyalty point type to loyalty points of another type as determined by the server computer system 120.

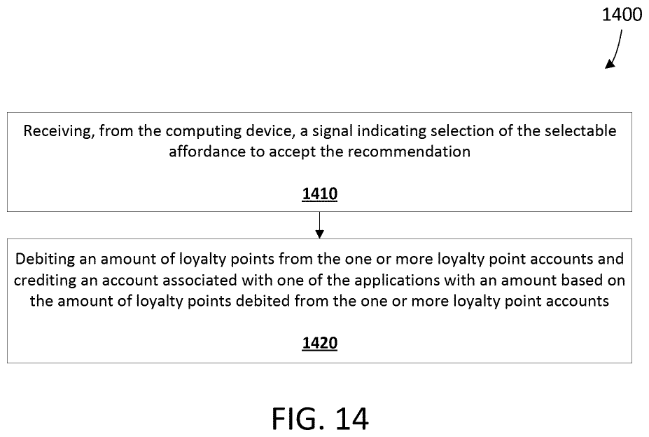

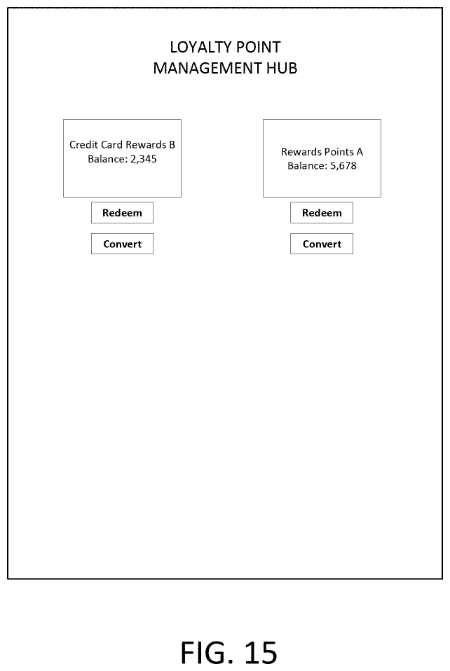

The selectable affordance may be selected by the user to accept the recommendation for redeeming loyalty points. Reference is made to FIG. 14, which illustrates, in flowchart form, a method 1400 for determining one or more applications installed on a computing device. The method 1400 may be implemented by a computing device having suitable processor-executable instructions for causing the computing device to carry out the described operations. The method 1400 may be implemented, in whole or in part, by the server computer system 120. The server computer system 120 may off-load some operations of the method 1400 to the computing device 110 (FIG. 1).

The method 1400 includes receiving, from the computing device, a signal indicating selection of the selectable affordance to accept the recommendation (step 1410).

Responsive to the user selecting the selectable affordance, the computing device 110 may send a signal to the server computer system 120 indicating selection of the selectable affordance. In embodiments where the recommendation includes an adjustable element, the signal may include information identifying the amount of loyalty points selected by the user.

The method 1400 includes debiting an amount of loyalty points from the one or more loyalty point accounts and crediting an account associated with one of the applications with an amount based on the amount of loyalty points debited from the one or more loyalty point accounts (step 1420).

Responsive to receiving the signal indicating selection of the selectable affordance, the server computer system 120 debits the amount of loyalty points from the one or more loyalty point accounts. The account associated with one of the applications installed on the computing device 110 is credited with an amount based on the amount of loyalty points debited from the one or more loyalty point accounts. As mentioned, the amount may be based on a conversion rate of loyalty points to dollar amount or a conversion rate of loyalty points of a particular type to loyalty points of another type. The account is thus credited with either a dollar amount or with loyalty points. The server computer system 120 may debit the amount of loyalty points from the one or more loyalty point accounts by, for example, sending a signal to a third party server associated with the loyalty point account. Similarly, the server computer system 120 may credit the account associated with the mobile application installed on the computing device 110 by sending a signal to a third party server associated with the mobile application.

It will be appreciated that the server computer system 120 may require account information to identify the account associated with the mobile application installed on the computing device 110. As such, the server computer system 120 may request access to the account information and this may be done by sending a signal to the computing device 110 requesting permission for accessing the account information. In another example, the server computer system 120 may request the account information from the user and this may be done by sending a signal to the computing device 110 requesting the account information. In yet another example, the server computer system 120 may require the user to link the account associated with the mobile application installed on the computing device 110 to the loyalty point management application and this may be done in manners similar to that described herein.

In one or more embodiments, rather than directly depositing or crediting the account associated with the mobile application installed on the computing device 110, the server computer system 120 may perform one or more operations to redeem the loyalty points. For example, the server computer system 120 may deposit an amount of money into an account associated with a mobile application installed on the computing device 110 using a credit card account associated with the user. For example, the server computer system 120 may charge $25.00 onto the credit card account associated with the user. The server computer system 120 may then apply loyalty points of a loyalty point type to the credit card account of the user based on a conversion rate. The loyalty points may be applied to the credit card account to offset the charge on the credit card account. For example, the server computer system 120 may apply 10,000 loyalty points to the credit card account and this may be done to offset the $25.00 charge on the credit card account. In this manner, the account associated with the mobile application installed on the computing device 110 is loaded using a credit card and loyalty points are used to offset the charge on the credit card. As such, loyalty points are redeemed based on the recommendation.

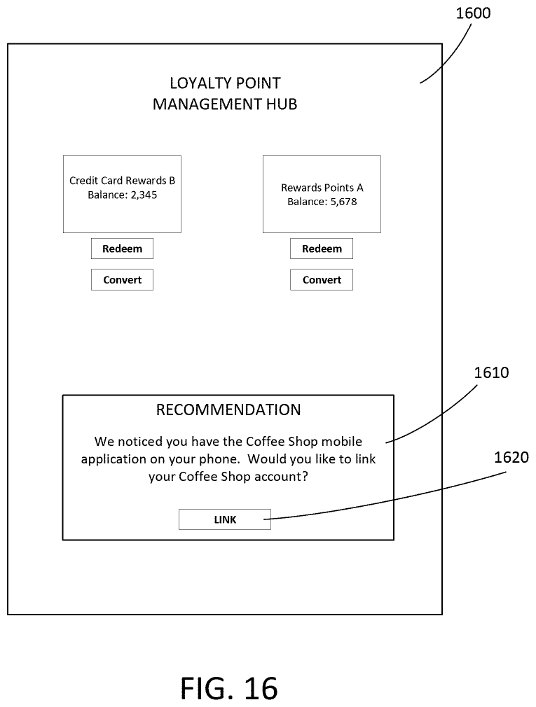

As mentioned, the recommendation may include a recommendation to link an account associated with an application installed on the computing device 110. An example interface 1600 that includes a recommendation 1610 is shown in FIG. 16. As can be seen, the recommendation 1610 is a recommendation to link an account associated with a “Coffee Shop” application installed on the computing device 110. The recommendation 1610 includes a selectable affordance 1620 that, when selected, causes the server computer system 120 to perform operations to link the account associated with the “Coffee Shop” application and this may be done in a manner similar to embodiments described herein. For example, at least some of the operations of method 500 described herein may be performed to link the account.

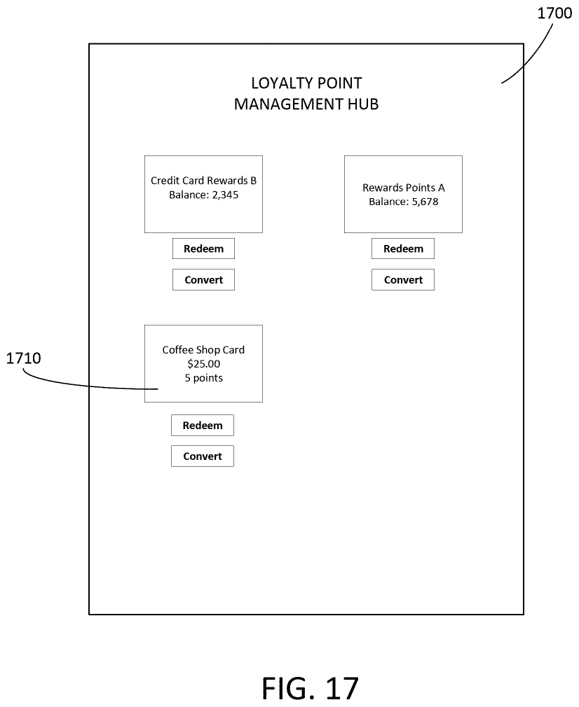

Once the account for the “Coffee Shop” application has been linked, the interface may be updated. An example updated interface 1700 is shown in FIG. 17. The interface 1700 is similar to the interface 1600 with the following exception. The interface 700 includes a graphic element 1710 associated with the account for the “Coffee Shop” application and displays loyalty point data obtained from a third party server associated with the “Coffee Shop” application. The graphic element 1710 may be selectable similar to the other graphic elements described herein.

The recommendations generated by the server computer system 120 may be triggered in response to account data obtained from the third party server associated with the application installed on the computing device 110. For example, the server computer system 120 may determine that an account balance of the account associated with the application installed on the computing device 110 drops below a threshold. Responsive to determining that the account balance drops below the threshold, the server computer system 120 may generate a recommendation to redeem loyalty points to top-up the account associated with the application installed on the computing device 110. For example, a recommendation to top-up the account for the “Coffee Shop” application may be generated by the server computer system 120 when the server computer system 120 determines that the balance of the account drops below $5.00 and when the server computer system 120 determines that the user has loyalty points in one or more of the linked loyalty point accounts that may be redeemed for the “Coffee Shop” application.

The recommendations generated by the server computer system 120 may additionally or alternatively be generated based on historical spending data of the user. For example, the server computer system 120 may analyze historical spending data of the user and may determine that the user typically spends $50 at a particular coffee shop in a given month. The server computer system 120 may identify that the user has enough loyalty points in one or more of the loyalty point accounts linked to the loyalty point management application to pay for their coffee for a month and may generate a recommendation to redeem loyalty points to purchase a $50 gift card for the particular coffee shop. The server computer system 120 may additionally or alternatively monitor transactions made on a credit card account of the user and may generate recommendations based on one or more of the transactions.

The server computer system 120 may determine when to present recommendations to the user and this may be based on the location of the user and/or the time of day. For example, location services may be enabled on the computing device 110 and may allow the server computer system 120 to track the location thereof. The server computer system 120 may identify that the user is located close to a coffee shop and may generate a recommendation for redeeming loyalty points at the coffee shop and may send a signal causing the computing device 110 to display the recommendation. As another example, the server computer system 120 may determine that the user typically purchases coffee in the morning and not in the afternoon and as such the server computer system 120 may only send a signal causing the computing device 110 to display a recommendation for redeeming loyalty points at a coffee shop during the morning hours.

As mentioned, the loyalty points management interface may include a selectable affordance for redeeming loyalty points and a selectable affordance for converting loyalty points to a different type of loyalty points.

In one or more embodiments, responsive to selection of the selectable affordance for redeeming loyalty points, the server computer system 120 may cause the computing device 110 to display one or more options for redeeming the loyalty points. The options may include, for example, a list of items that may be purchased using the loyalty points. In another embodiment, responsive to selection of the selectable affordance for redeeming loyalty points, the server computer system 120 may direct the computing device 110 to a mobile application or website associated with the loyalty points program.

In one or more embodiments, responsive to selection of the selectable affordance for converting loyalty points, the server computer system 120 may cause the computing device 110 to display one or more options for converting loyalty points. For example, the server computer system 120 may generate a list of all types of loyalty points linked to the loyalty point management application and may allow the user to convert loyalty points of a first type to loyalty points of a second type and this may be based on a conversion rate stored in the database 140.

Within the loyalty point management application, the user may define goals for saving loyalty points for a particular purchase. For example, the user may wish to purchase a flight that costs 300,000 loyalty points. As such, the loyalty point management application may include an option to set a goal and the user may set the goal of 300,000 loyalty points. The server computer system 120 may track progress of the goal and may update an indicator used to indicate progress of the goal responsive to the user earning additional loyalty points. The server computer system 120 may further generate recommendations to help the user achieve the goal and this may be based on, for example, promotions to earn loyalty points at an increased rate.

The methods described herein may be modified and/or operations of such methods combined to provide other methods.

Example embodiments of the present application are not limited to any particular operating system, system architecture, mobile device architecture, server architecture, or computer programming language.

It will be understood that the applications, modules, routines, processes, threads, or other software components implementing the described method/process may be realized using standard computer programming techniques and languages. The present application is not limited to particular processors, computer languages, computer programming conventions, data structures, or other such implementation details. Those skilled in the art will recognize that the described processes may be implemented as a part of computer-executable code stored in volatile or non-volatile memory, as part of an application-specific integrated chip (ASIC), etc.

As noted, certain adaptations and modifications of the described embodiments can be made. Therefore, the herein discussed embodiments are considered to be illustrative and not restrictive.

1. A server computer system comprising:
a processor;
a communications module coupled to the processor; and
a memory coupled to the processor, the memory storing instructions that, when executed, configure the processor to:
obtain loyalty point data associated with one or more loyalty point accounts;
send, via the communications module and to a computing device, a command requesting a list of applications installed on the computing device;
receive, via the communications module and from the computing device, a list of applications installed on the computing device;
analyze the list of applications to identify one or more applications eligible for loyalty point redemption;
generate a recommendation for redeeming loyalty points from one or more of the loyalty point accounts for an account associated with the one or more applications eligible for loyalty point redemption; and
send, via the communications module and to the computing device, a signal causing the computing device to display a selectable affordance to accept the recommendation.

2. (canceled)

3. The server computer system of claim 1, wherein the list of applications installed on the computing device is received from the computing device in one of a plain text format or a HyperText Markup Language format.

4. (canceled)

5. The server computer system of claim 1, wherein the instructions, when executed, further configure the processor to:
store, in a database, a list that includes only the applications installed on the computing device that are identified as being eligible for loyalty point redemption.

6. The server computer system of claim 1, wherein when analyzing the list of applications, the instructions, when executed, further configure the processor to:
perform, using a lookup table stored in a database, a lookup of each application installed on the computing device to determine if the application is eligible for loyalty point redemption.

7. The server computer system of claim 1, wherein the instructions, when executed, further configure the processor to:
receive, via the communications module and from the computing device, a signal indicating selection of the selectable affordance to accept the recommendation; and
responsive to receiving the signal indicating selection of selectable affordance to accept the recommendation, debit an amount of loyalty points from the one or more loyalty point accounts and credit the account associated with the one or more applications with an amount based on the amount of loyalty points debited from the one or more loyalty point accounts.

8. The server computer system of claim 7, wherein the instructions, when executed, further configure the processor to:
obtain, from a database, a conversion rate for converting loyalty points to a dollar amount,
wherein the amount credited to the account associated with the one or more applications is determined based on the obtained conversion rate.

9. The server computer system of claim 7, wherein the account associated with the one or more applications is one of the one or more loyalty point accounts.

10. The server computer system of claim 1, wherein when obtaining loyalty point data associated with one or more loyalty point accounts, the instructions, when executed, further configure the processor to:
obtain authentication information associated with the one or more loyalty point accounts;
send, via the communications module and to a third party server associated with the one or more loyalty point accounts, a signal that includes the authentication information and a request for loyalty point data; and
receive, via the communications module and from the third party server associated with the one or more loyalty point accounts, the loyalty point data.

11. The server computer system of claim 10, wherein the recommendation includes a recommendation to link an account associated with one or more of the applications installed on the computing device.

12. The server computer system of claim 1, wherein the instructions, when executed, further configure the processor to:
engage an application programming interface (API) associated with one of the applications installed on the computing device to obtain an account balance of the account associated with the one or more applications;
determine that the account balance is below a threshold; and
responsive to determining that the account balance is below the threshold, generate the recommendation.

13. A method comprising:
obtaining loyalty point data associated with one or more loyalty point accounts;
sending, via a communications module and to a computing device, a command requesting a list of applications installed on the computing device;
receiving, via the communications module and from the computing device, a list of applications installed on the computing device;
analyzing the list of applications to identify one or more applications eligible for loyalty point redemption;
generating a recommendation for redeeming loyalty points from one or more of the loyalty point accounts for an account associated with the one or more applications eligible for loyalty point redemption; and
sending, via the communications module and to the computing device, a signal causing the computing device to display a selectable affordance to accept the recommendation.

14. (canceled)

15. The method of claim 13, wherein the list of applications installed on the computing device is received in one of a plain text format or a HyperText Markup Language format.

16. (canceled)

17. The method of claim 13, further comprising:
storing, in a database, a list that includes only the applications installed on the computing device identified as being eligible for loyalty point redemption.

18. The method of claim 13, wherein analyzing the list of applications comprises:
performing, using a lookup table stored in a database, a lookup of each application installed on the computing device to determine if the application is eligible for loyalty point redemption.

19. The method of claim 13, further comprising:
receiving, from the computing device, a signal indicating selection of the selectable affordance to accept the recommendation; and
responsive to receiving the signal indicating selection of selectable affordance to accept the recommendation, debiting an amount of loyalty points from the one or more loyalty point accounts and crediting the account associated with the one or more applications with an amount based on the amount of loyalty points debited from the one or more loyalty point accounts.

20. A non-transitory computer readable storage medium comprising processor-executable instructions which, when executed, configure a processor to:
obtain loyalty point data associated with one or more loyalty point accounts;
send, via a communications module and to a computing device, a command requesting a list of applications installed on the computing device;
receive, via the communications module and from the computing device, a list of applications installed on the computing device;
analyze the list of applications to identify one or more applications eligible for loyalty point redemption;
generate a recommendation for redeeming loyalty points from one or more of the loyalty point accounts for an account associated with the one or more applications eligible for loyalty point redemption; and
send, via the communications module and to the computing device, a signal causing the computing device to display a selectable affordance to accept the recommendation.
